(19) United States
(12) Patent Application Publication
(10) Pub. No.: US 2013/0066567 A1
(43) Pub. Date: Mar. 14, 2013

(54) Method and 3D Detector for Measuring a Vector of Mechanical Oscillations

(71) Applicants: Anatoly Alekseevich Speranskiy, Moscow (RU); Alexander Igorevich Prokhorov, Moscow (RU)

(72) Inventors: Anatoly Alekseevich Speranskiy, Moscow (RU); Alexander Igorevich Prokhorov, Moscow (RU)

(21) Appl. No.: 13/699,278

(22) PCT Filed: May 20, 2010
(86) PCT No.: PCT/RU10/00253

§ 371 Date: Nov. 20, 2012

(51) Int. Cl. G06F 17/16

(52) U.S. Cl. 702/34

(57) ABSTRACT

A method and 3D detector for measuring a vector of mechanical oscillations. The invention relates to the field of measurement technology and particularly to measurement of parameters of mechanical oscillations over a wide frequency band. The proposed method for detection and conversion of a vector of mechanical oscillations is realized using a 3D detector in the form of an equilateral trihedral pyramid with the faces isoclinic to the pyramid base at specified angles φ, and that detachable detection units (oscillation dipoles) are located in the center of each face at a specified point of its symmetry axis, which makes it possible to spatially, physically and electrically align information on the vector components and reliably measure the vector of mechanical oscillations. The invention can be used for measurement of wave parameters of mechanical oscillations of various objects in

### CROSS-REFERENCE TO RELATED APPLICATION

This application claims the benefit of the priority filing date in PCT/RU2010/000253 and referenced in WIPO Publication No. WO2011/145968 A1. The earliest priority date claimed is May 20, 2010.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to the field of measurement technology and particularly to the measurement of mechanical oscillations parameter over a wide frequency band. It can be used for measuring wave parameters of mechanical oscillations of various objects in construction, machine building, acoustics, etc.

In regards to measuring parameters of mechanical oscillations, various methods are known for converting a definable parameter to a measured signal that is physical in nature (electric, optical, etc.). Most often used for measurement of mechanical oscillations are one-component (having one sensing element) piezoelectric transducers that measure the projection of the oscillatory acceleration vector on the measurement axis of the transducer. To measure the magnitude and direction of an oscillatory acceleration vector, two or three sensing elements packaged in a common housing are used. Two sensing elements make it possible to determine the direction of the oscillatory acceleration vector in a plane, and three sensing elements in three orthogonal directions make it possible to determine the magnitude and direction of the vector in space.

For critical measurements, “three-component” vibration transducers are used. They comprise three orthogonally oriented one-component (monoscopic or scalar) transducers in a common housing (“3-in-1”). In such engineering solution, the transducer sensing elements are, strictly speaking, separated spatially, physically and electrically, and the vector components they measure can have substantial phase mismatches with respect to the measured parameters. In addition to the introduced phase mismatches, piezoelectric crystals of one-component transducers have their process-driven tensor conversion matrix imparting each transducer with individual parameters of lateral sensitivity. Because of this, measurements of three one-component transducers packaged in the same housing cannot be equated to projections of the oscillatory acceleration vector because they introduce distortions to the magnitude and direction of the vector of measured oscillations. For time matching (synchronization) of measured vector components, manufacturers add ICP/ISOTRON-type conditioning integrated circuits to three-channel transducers.

The information content of the metrological arrangement of a three-component transducer comprising three one-component transducers is also affected by the precision of the orthogonal arrangement of the one-component transducers' measurement axes in the common housing.

The 3D oscillation wave at the measurement point is transferred to a (“3-in-1”) transducer, with its measurement axis Z perpendicular to the housing base, by means of “tension-compression” conversion, while it is transferred to the two other transducers by means of “shift” conversion. The physics of these processes is substantially different, not just in linear coefficients of the tensor matrix of conversion (which can be compensated by tuning the gain factors), but also in the difference of resonance frequencies of normal (longitudinal) and tangential (lateral) deformations of the common housing.

The relationship between longitudinal and lateral resonances is as follows:

f(res.lat.)=f(res.y)=f(res.x)=(1/3)f(res.z)=(1/3)f(res.long.)

In metrology, it is assumed that the linear range of operating frequencies is within 0.7 of the lowest resonance frequency, in this case—of f (res.lat). Therefore, the operating frequency band of such transducer along axes X and Y would be about 20% of the operating frequency band along axis Z. Thus, the resonance characteristics of the transmitting medium along the orthogonal axes are a limiting factor when determining the frequency domain for a reliable measurement of diagnostic vector parameters.

Known is patent No. 2229136 RU for a three-component vibration accelerometer with one sensing element. In this device, one measurement component (Z) of the three orthogonal components is determined by means of “a tension-compression” physical conversion, and the other two components (X and Y) are determined by means of a “shear” conversion in the sensing element. Because of the substantial difference in resonance frequencies of the “tension-compression” processes (f res.z=25-28 kHz) and resonance frequencies of the “shear” processes (f res.x,y=6-8 kHz), the possibility of using them for a reliable reconstruction of diagnostic vector parameters is limited to the frequencies of 3-4 kHz.

Thus, instead of the claimed frequency band of 10 Hz-15 kHz, the transducers per patent No. 2229136 RU actually realize vector properties of up to 3 kHz (20% of the claimed band). An advantage of the development per patent No. 2229236 RU is the synchronism of the electric conversion (measurement) of components in the form of a simultaneous measurement of vector projections on the measurement axes of the transducer's sensing element. However, due to the fact that the shear plane is shifted with respect to the object measurement point by an amount commensurate with the size of the sensing element, only the measurement axis Z (“tension-compression”) aligns with the measurement point, while the “shear” axes (X and Y) are physically and spatially separated from the measurement point. Moreover, aside from this unfavorable result from a process point of view, the arrangement of asymmetrically positioned reading of the charge, results in low repeatability of transducer characteristics.

The closest analog to the proposed method for accurate measurement of the mechanical oscillations vector is the method described in patent No. 2383025 RU. The patent proposes a device comprising three sensing elements in the form of piezoelectric or bimorph plates rigidly cantilever-attached to the common housing made in the form of a trihedral pyramid with three orthogonal planes. By means of the three sensing elements located close to the measurement point, the oscillatory acceleration vector is resolved into three orthogonal components, the measurement of which makes it possible to derive the magnitude and direction of the measured vector.

### SUMMARY

The proposed invention solves the technical problem of developing a method and a 3D detector for the combined detection and systemic conversion of measured mechanical oscillations over the entire range of an object's diagnostic parameters that satisfies all the major requirements for validly measuring vector components.

The technical solution of the stated problem is that electric signals are read off the sensing elements of a 3D detector of mechanical oscillations that are located on the housing planes, forming an equilateral trihedral pyramid with faces isoclinic to the housing base. In the center of each face, at a certain point of its symmetry axis, there is an oscillation dipole that is the unit of detection, conversion and reading of the measured oscillations spectrum. The measurement axes of each of the three oscillation dipoles are perpendicular to their face planes and intersect at the pyramid base center, which is also the measurement point of the detector. A physically and electrically connected synchronous conversion of spatial oscillations in the direction of three 3D-connected measurement axes takes place. The method attribute is that the metrology circuit of oscillation dipoles uses the same-type physical-mechanical “tension-compression” conversion. With respect to the 3D detector attachment point, a circularly symmetric arrangement of measurement axes makes it possible to meet system requirements of vector-phase measurements.

Each oscillation dipole performs precision 1D-linear oscillatory conversion with tensor matrix coefficients, with low lateral sensitivity of detection elements. Pre-selection of the oscillation dipoles' sensing elements makes it possible to ensure a high repeatability of overall technical characteristics and improve production manufacturability. Individual manufacturing of oscillation dipoles as functional units does not require further adjustment, which considerably improves the procedure for the final assembly of a 3D detector. The three vector projections that are “measured with a pyramid” and inter-connected in space and time, can be affine-transformed into three vector projections in the Cartesian coordinate system of the monitored object.

The technical result of the embodiment of the invention is the development of a method and a 3D detector for detection and synchronous conversion of measured mechanical oscillations components over the entire range of an object's diagnostic parameters. The method meets all major requirements to validity measure components of an oscillation vector:

a) the measured components are connected spatially due to the circularly symmetric designed intersection of the oscillation dipoles' measurement axes at the common point of the detector isotropic housing base;
b) the measured components are connected physically due to an alignment at a common point of intersection of the oscillation dipoles' axes and the measurement point of the detector attachment on the contour surface of the monitored object;
c) the measured components are electrically connected due to the symmetric equidistance of oscillation dipoles from the measurement point, and synchronously convert oscillation fronts to charges for subsequent construction of diagnostic parameters in a vector form;
d) component measurements are matched in terms of resonance characteristics because the metrology circuit uses oscillation dipoles of the same-type of physical-mechanical “tension-compression” conversion;
e) the 3D detector and its metrology circuit are capable of manufacture because it is possible to ensure high repeatability of technical characteristics of oscillation dipoles.

It follows from the comparison of the analog and the proposed method that they have the following common essential features: detection and conversion of measured oscillations vector projections using three detectors of mechanical oscillations of the same type located on orthogonal planes that form an equilateral trihedral pyramid with faces isoclinic to the base, while the distinctive essential features are that the proposed method for detection and conversion of vector components of mechanical oscillations is realized using three detectors of mechanical oscillations of the same type located on planes that form an equilateral trihedral pyramid with faces isoclinic to the pyramid base at specified angles φ, and that detachable detection units (oscillation dipoles) are located in the center of each face at a specified point of its symmetry axis, wherein the measurement axes of the oscillation dipoles intersect at the common measurement point at the center of the 3D detector base, which makes it possible to spatially, physically and electrically align the information on the vector components and reliably measure the vector of mechanical oscillations at the measurement point.

The proposed invention has novelty because the applicants have found no confirmation of the use of the same method and device for the same purpose.

The applicants are not aware of technical solutions that have the features matching the distinctive features of the claimed method and device; therefore, we believe that the technical solution meets the “inventive step” criterion.

The claimed invention can be widely used for measuring parameters of mechanical oscillations of various objects in construction, machine building, acoustics, etc.; therefore, the invention meets the “industrial applicability” criterion.

### FIGURES

The invention is illustrated in the drawings (FIG. 1 and 2) which show schematically a 3D detector that realizes the method for precise simultaneous determination of the three components of the vector of mechanical oscillations.

FIG. 1 shows the top view of the 3D detector that realizes the proposed method.

Axyᵢ²=Axᵢ²+Ayᵢ²

Axᵢ=Axyᵢ Cos βᵢ Ayᵢ=Axyᵢ Sin βᵢ

Axᵢ=Nxᵢ−Txᵢ Ayᵢ=Nyᵢ−Tyᵢ

Axyᵢ²=Nxyᵢ²+Txyᵢ²

Nxyᵢ²=Nxᵢ²+Nyᵢ² Txyᵢ²=Txᵢ²+Tyᵢ²

Nxᵢ=Nxyᵢ Cos αᵢ Nyᵢ=Nxyᵢ Sin αᵢ

Txᵢ=Txyᵢ Sin αᵢ Tyᵢ=Txyᵢ Cos αᵢ Aᵢ²Axyᵢ²+Azᵢ² O(X,Y,Z)

FIG. 2 shows the side view of the 3D detector that realizes the proposed method.

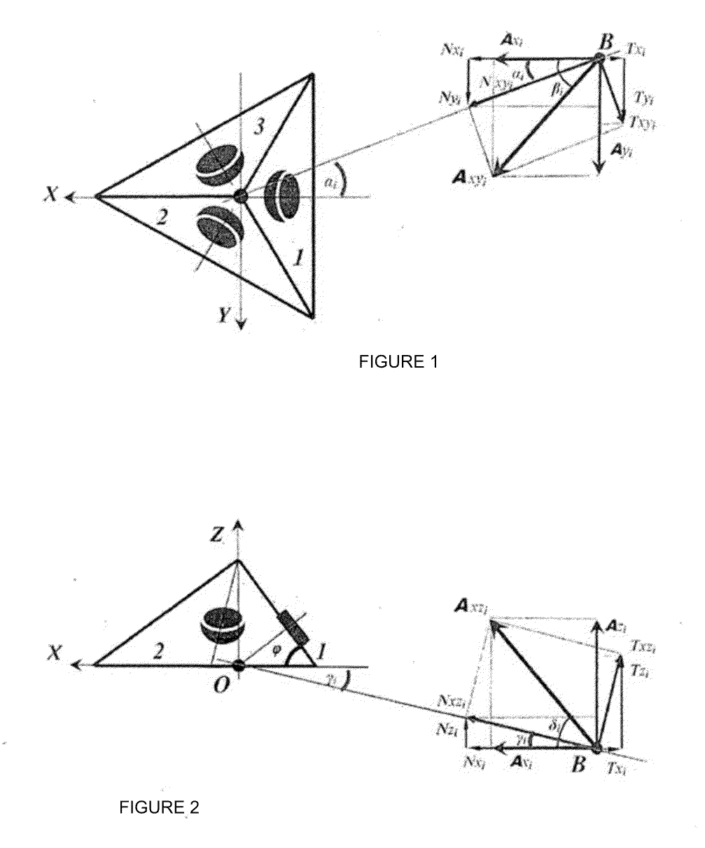

Axzᵢ²=Axᵢ²+Azᵢ²

Axᵢ=Axzᵢ Cos δᵢ Azᵢ=Axzᵢ Sin δᵢ

Axᵢ=Nxᵢ−Txᵢ Azᵢ=Nzᵢ−Tzᵢ

Axzᵢ²=Nxzᵢ²+Txzᵢ²

Nxzᵢ²=Nxᵢ²+Nzᵢ² Txzᵢ²=Txᵢ²+Tzᵢ²

Nxᵢ=Nxzᵢ Cos γᵢ Nzᵢ=Nxzᵢ Sin γᵢ

Txᵢ=Txzᵢ Sin γᵢ Tzᵢ=Txzᵢ Cos γᵢ

Both Figures use the following symbols: 1,2,3 are faces of the 3D detector housing;

B is the oscillation source;
O is the measurement point of the detector;
A is the oscillation action;
N are normal components;
T are tangential components;
α is the source bearing in plane XY;
Y is the source bearing in plane XZ;
β, δ is the 3D orientation of the action;
i are detection piezoelectric packets, i=1, 2, 3;
φ is the angle of face to the base.

### DETAILED DESCRIPTION

The method for 3D detection and synchronous conversion of parameters of mechanical oscillations is realized as follows.

According to the laws and principles of continuum mechanics, waves of 3D mechanical oscillations coming from perturbation sources acting on an object, reach the point at the contour surface of the monitoring object where it is necessary to take a measurement. When a 3D detector is placed at this point, it is called the measurement point, and it in turn becomes a local source of dynamic superposition of 3D oscillations that transfers the spectrum of oscillations to the oscillation dipole. Due to the circularly symmetric arrangement of oscillation dipoles with respect to the base of the isotropic housing and to their equidistant arrangement with respect to the measurement point, the spectrum of oscillation waves simultaneously (synchronously) reaches the sensing elements of all three oscillation dipoles. The sensing elements perform synchronous tensor transformation of vector projections of measured oscillations, and from those it would be easy in time to reconstruct the spectrum of vectors in terms of their magnitude and direction in space. The detection method realizes the effect of “focusing” of information transmitted from the measurement point to the oscillation dipole, and not just in the spatial and electric sense but also in the physical sense.

The Matrix of Recalculation of 1D Projections of a Vector on Orthogonal Measurement Axes of Oscillation dipoles to the Orthogonal Coordinate System of a 3D Detector

The relations between measured components of the projection of action A in the coordinate system of a 3D detector are shown in the equations below.

1. A method for reliable determination of the vector of mechanical oscillations over a broad frequency band comprising the process of synchronous measurement of three components of the vector of mechanical oscillations using sensing elements located on faces of the housing of a 3D detector, with the faces forming a trihedral pyramid, wherein, in order to increase measurement reliability, the mechanical oscillation arrives synchronously from a detection point via an isotropic housing of the 3D detector at sensing elements located symmetrically on the detector housing and equidistant with respect to a measurement point of an object of monitoring, and in the sensing elements a tensor transformation of measured oscillations takes place, via same-type processes of “tension-compression” conversion in a direction of measurement axes intersecting at the measurement point, to signals that are proportional to the three components of the vector of mechanical oscillations, the components are resolved in a direction of the measurement axes that are spatially, physically and electrically aligned at the measurement point, which makes it possible to reliably measure magnitude and reconstruct in space the direction of the vector of mechanical oscillations.

2. A device in the form of a 3D detector of mechanical oscillations for measuring the vector of oscillations over a broad frequency band comprising three sensing elements attached to faces of an isotropic housing of the detector that are isoclinic to a housing base and form an equilateral trihedral pyramid with the base that is the base of the detector housing, wherein, in order to increase measurement reliability and improve production manufacturability, the sensing elements of the detector are made in the form of removable detection units, or oscillation dipoles, located circularly symmetrically and equidistantly with respect to a detector measurement point which aligns with the center of the detector housing base and is the common intersection point of a measurement axes of the oscillation dipoles, while mounting seats of the oscillation dipoles are located on an axis of symmetry of each face, and a measurement axes of the sensing elements form a pyramid that is mirror-symmetric with respect to faces of the detector pyramid, with a vertex at the detector measurement point.
